(19) United States
(12) Patent Application Publication
(10) Pub. No.: US 2013/0277080 A1
(43) Pub. Date: Oct. 24, 2013

(54) HAND-HELD POWER TOOL

(71) Applicant: HILTI AKTIENGESELLSCHAFT, Schaan (LI)

(72) Inventors: Markus Hartmann, Mauerstetten (DE); Eduard Pfeiffer, Halblech (DE)

(73) Assignee: Hilti Akiengesellschaft, Schaan (LI)

(21) Appl. No.: 13/864,829

(22) Filed: Apr. 17, 2013

(30) Foreign Application Priority Data
Apr. 19, 2012 (DE) 10 2012 206 451.6

(51) Int. Cl. B25D 17/24

(52) U.S. Cl. CPC B25D 17/245
USPC 173/212

(57) ABSTRACT

A hand-held power tool has a pneumatic striking mechanism (6). The striking mechanism (6) has a motor-driven exciter (12), a striker (13) and a pneumatic chamber (15) arranged along a working axis (10) between the exciter (12) and the striker (13). At least 20% of the volume of the pneumatic chamber (15) is filled with a monoatomic gas.

This claims the benefit of German Patent Application DE 10 2012 206 451.6, filed Apr. 19, 2012 and hereby incorporated by reference herein.

The present invention relates to a chiseling hand-held power tool, for example, a hammer drill having a pneumatic striking mechanism that is especially driven by an electric motor.

### BACKGROUND

The periodic strikes of a hammer drill onto a drill chisel have to be countered with a holding force by the user. The user perceives the periodic load reversals as vibrations. The amplitude of the vibrations should be as small as possible. Handles with a cushioned attachment as well as mass dampers serve to reduce the amplitude transferred into the arm of the user. These cushioning systems, however, have their limitations, not least because the handle used for guiding the hammer drill has to be affixed sufficiently stiffly.

### SUMMARY OF THE INVENTION

The present hand-held power tool with a pneumatic striking mechanism reduces the amplitude of the vibrations already when they are generated in the striking mechanism. The striking mechanism has a motor-driven exciter, a striker and a pneumatic chamber arranged along a working axis between the exciter and the striker. At least 20% of the volume of the pneumatic chamber is filled with a monoatomic gas, for instance, argon. It has been recognized that the striking mechanism according to the invention can transmit the same impact energy to a tool as a striking mechanism completely filled with air. The pressure needed for this purpose during the compression of the pneumatic chamber, however, is less, and the load reversals decrease.

One embodiment provides that the striking mechanism is arranged inside an inner housing that closes off a gas-tight intermediate chamber with the striking mechanism. The pneumatic chamber and the intermediate chamber can be connected by ventilation openings of the striking mechanism. The monoatomic gas is sealed off inside the pneumatic chamber and the intermediate chamber. An exchange of gas between the two chambers is advantageous, among other things, in order to switch off the pneumatic striking mechanism.

One embodiment provides that the inner housing has a bellows. The inner housing does not have a fixed volume, but rather, it adjusts its volume in such a way that the internal pressure is equal to the external pressure. As a consequence, any exchange of gas with the environment due to leakage is advantageously reduced.

### BRIEF DESCRIPTION OF THE DRAWING

The description that follows explains the invention on the basis of figures and embodiments provided by way of examples. The figures show the following:

FIG. 1 a hammer drill.

Unless otherwise indicated, the same or functionally equivalent elements are designated by the same reference numerals in the figures.

### DETAILED DESCRIPTION

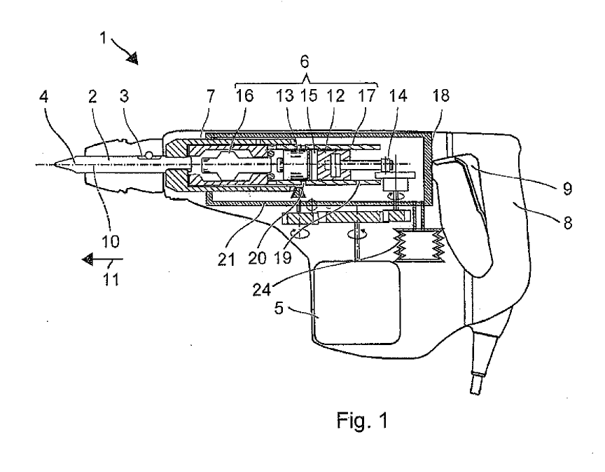

FIG. 1 schematically shows a hammer drill 1 as an example of a chiseling hand-held power tool. The hammer drill 1 has a tool socket 2 into which a shank end 3 of a tool, e.g. a drill chisel 4, can be inserted. A motor 5 that drives a striking mechanism 6 and a drive shaft 7 constitutes the primary drive of the hammer drill 1. A user can hold the hammer drill 1 by means of a handle 8 and can start up the hammer drill 1 by means of a system switch 9. During operation, the hammer drill 1 continuously rotates the drill chisel 4 around a working axis 10, and in this process, it can hammer the drill chisel 4 into a substrate in the striking direction 11 along the working axis 10.

The striking mechanism 6 is a pneumatic striking mechanism 6. An exciter 12 and a striker 13 are installed in the striking mechanism 6 so as to be movable along the working axis 10. The exciter 12 is coupled to the motor 5 via an eccentric 14 or a toggle element, and it is forced to execute a periodic linear movement. An air spring formed by a pneumatic chamber 15 between the exciter 12 and the striker 13 couples the movement of the striker 13 to the movement of the exciter 12. The striker 13 can strike a rear end of the drill chisel 4 directly or it can transmit part of its pulse to the drill chisel 4 indirectly via an essentially stationary intermediate striker 16. In the depiction provided by way of an example, the exciter 12 and the striker 13 are configured so as to be piston-shaped and are installed inside a cylindrical guide tube 17 along the working axis 10. The guide tube 17 seals off the pneumatic chamber 15 in the radial direction. The striking mechanism 6 and preferably the other drive components are arranged inside a machine housing 18.

The entire pneumatic chamber 15, that is to say, 100% of its volume, is filled with argon. When the pneumatic chamber 15 is compressed, this monoatomic gas can absorb a larger amount of energy than when filled with air at the same pressure. The load reversals during the compression are less, which is noticeable by the user in the form of less vibration.

The guide tube 17 has several radial ventilation openings 19, 20. First ventilation openings 19 serve to compensate for gas losses from the pneumatic chamber 15 which can especially occur during the compression of the pneumatic chamber 15. Second ventilation openings 20 aid the switch-off of the striking mechanism 6 when an empty strike occurs. The striker 13 seals off the second ventilation openings 20 vis-à-vis the pneumatic chamber 15 during the chiseling operation. The axial position of the second ventilation openings 20 is configured in such a way that, in the case of an empty strike, the striker 13 is moved in the striking direction 11 beyond the second ventilation openings 20, and the second ventilation openings 20 are no longer sealed vis-a-vis the pneumatic chamber 15.

A gas-tight inner housing 21 is arranged inside the machine housing 17. The inner housing 21 surrounds the striking mechanism 6 in the radial direction. The walls of the inner housing 21 do not have openings. On the rear in the striking direction 11, the inner housing 21 is closed off at an outer wall of the striking mechanism 6 by means of a sealing ring 22. The front of the inner housing 21 is closed, for example, by a wall, or else sealed off at an outer wall of the striking mechanism 6 by means of a sealing ring. The eccentric 14 and other gear components can be installed, for example, inside the inner housing 21. A shaft leading into the inner housing 21 is sealed off by means of a sealing ring so as to be appropriately gas-tight. The intermediate chamber 23 sealed off by the inner housing 21 is filled with the monoatomic gas like the pneumatic chamber 15 is. All of the ventilation openings 19, 20 of the striking mechanism 6 end inside the inner housing 21. A gas exchange between the pneumatic chamber 15 and the inner housing 21 is possible, whereas a gas exchange with other spaces is prevented. The striker 13 and the intermediate striker 16 are provided with sealing elements and/or they slide in sealing elements that prevent any gas exchange through the tool socket 2.

The inner housing 21 can contain a bellows 24 that can expand into the machine housing 18. The expansion of the monoatomic gas due to thermal changes can be accommodated by the bellows 24. The bellows 24 contains, for instance, a concertina-type bellows 24 made of a plastic film. The bellows 24 allows a volume change without the use of force, which is why the pressure present inside the bellows 24 is approximately the same as the ambient pressure in the machine housing (normal pressure typically). Other configurations provide for a shell made of a soft plastic. In another embodiment, the walls of the inner housing 21 are made of a soft plastic. In the inflated state, the volume of the bellows 24 can increase to 20% to 40% of the total volume of the inner housing 21 and of the pneumatic chamber 15.

The embodiment described in detail can be modified in various ways. In particular, the exciter 12 can be configured so as to be pot-like in that the guide tube 17 and the exciter 12 are rigidly connected to each other. The guide tube 17 is moved along periodically by the motor 5. As an alternative, the guide tube 17 can be connected to the striker 13 to form a pot-like striker.

The pneumatic chamber 15 and the inner housing 21 can be filled with a gas mixture. This gas mixture contains at least 20 vol-% of argon, preferably at least 50 vol-%. The other components are air in its usual composition consisting primarily of nitrogen and oxygen. Even though the damping effect is less than with a gas mixture consisting of pure argon, the loss of argon due to leakage is less. The hand-held power tool exhibits a more uniform behavior over its service life or between its maintenance intervals.

What is claimed is:

1. A hand-held power tool comprising:
a pneumatic striking mechanism having a motor-driven exciter, a striker and a pneumatic chamber arranged along a working axis between the exciter and the striker, at least 20% of the volume of the pneumatic chamber being filled with a monoatomic gas.

2. The hand-held power tool as recited in claim 1 wherein the monoatomic gas is argon.

3. The hand-held power tool as recited in claim 1 wherein an entirety of the pneumatic chamber is filled with argon.

4. The hand-held power tool as recited in claim 1 further comprising an inner housing, the striking mechanism being arranged inside the inner housing, the inner housing closing off a gas-tight intermediate chamber with the striking mechanism.

5. The hand-held power tool as recited in claim 4 wherein the pneumatic chamber and the intermediate chamber are connected by ventilation openings of the striking mechanism.

6. The hand-held power tool as recited in claim 5 wherein the inner housing has a bellows.

7. The hand-held power tool as recited in claim 4 wherein the inner housing has a bellows.
